(19) United States
(12) Patent Application Publication
(10) Pub. No.: US 2016/0009158 A1
(43) Pub. Date: Jan. 14, 2016

(54) ROTARY DAMPER FOR A VEHICLE

(71) Applicant: ZF Friedrichshafen AG, Friedrichshafen (DE)

(72) Inventors: Detlef BAASCH, Friedrichshafen (DE); Daniel WOLF, Friedrichshafen (DE)

(21) Appl. No.: 14/770,950

(22) PCT Filed: Feb. 3, 2014
(86) PCT No.: PCT/EP2014/052005

§ 371 Date: Aug. 27, 2015

(30) Foreign Application Priority Data
Feb. 28, 2013 (DE) 102013203331.1

(51) Int. Cl. B60G 13/08; F04C 2/10; F16F 15/023; F04C 2/14; B60G 17/08; F16F 9/53

(52) U.S. Cl. CPC B60G 13/08; B60G 17/08; F16F 9/532; F16F 9/535; F16F 15/0235; F04C 2/14; F04C 2/101; F04C 2/102; B60G 2202/22; B60G 2202/424; F16F 2232/06

(57) ABSTRACT

A rotary damper, for a vehicle, for damping relative movements between vehicle wheels and the vehicle body. The at least one gear assembly has several gearwheels in functional connection by virtue of rotational movement of which hydraulic medium can be displaced for the purpose of hydraulic damping for the vehicle.

This application is a National Stage completion of PCT/EP2014/052005 filed Feb. 3, 2014, which claims priority from German patent application serial no. 10 2013 203 331.1 filed Feb. 28, 2013.

### FIELD OF THE INVENTION

The present invention concerns a rotary damper for a vehicle, for damping relative movements.

### BACKGROUND OF THE INVENTION

From automotive technology linear dampers are known, for the damping of linear movements. Furthermore, from the document DE 10 2008 042 389 A, a rotary damper is also known, which consists of an inner, fixed part and an outer part that can rotate relative to the inner part and that is connected to a lever for producing the rotation. Between the inner part and the outer part there is arranged a frictional clutch in the form of a disk clutch, whose disks are connected fixed, in alternation, to the two parts, In the area of the lever the outer part is fixed to a first component of a spindle gear, which can move in rotation on balls over a second component and during this, undergoes an axial movement guided by a ramp on the second component. Accordingly, rotational movement of the outer part produced by the spindle drive is converted to an axial movement of the first component and thus also of the outer part, in order to bring the friction surfaces of the clutch into contact, This brings about a coupling of the inner and outer parts, which brakes the outer part and therefore damps the rotary movement.

### SUMMARY OF THE INVENTION

The purpose of the present invention is to propose a rotary damper with as compact a structure as possible.

According to the invention, that objective is achieved by virtue of the characteristics and advantageous design features that emerge from the description and the drawings.

For a compact structure, a rotary damper preferably for a vehicle, for damping relative movements between the vehicle wheels and the vehicle body is proposed, which comprises at least one gear assembly with several functionally connected components or gearwheels, through whose rotary movement, for example by virtue of the rotary movement of which, media (such as hydraulic media) are set into motion with a hydraulic damping effect of hydrodynamic, hydrostatic or rheological nature upon the movement.

In this way the rotary movement and thus also a relative movement, for example transmitted by means of a gear system or suchlike, can be hydraulically damped as desired. Thanks to the use of a lever the vertical movement can be changed to a pivoting movement, whereby the pivoting movement is translated into a more rapid rotational movement by the gear system. By virtue of the fact that a hydraulic pump integrated in the gear system is provided, a corresponding hydraulic damping action can be produced for example by short-circuiting the suction and pressure sides. The short-circuiting can take place for example by way of a throttle or even by way of an electrically actuated proportional valve or the like, which is opened according to the degree of damping desired or closed completely.

For example, it can also be provided that the short-circuiting is achieved through an approximately leakproof housing without any inlet or outlet, so that the throttle is provided by leakage. This is particularly advantageous when the proposed rotary damper is intended to produce the maximum damping effect for most of the operating time.

In an advantageous embodiment variant of the invention it can be provided that for additional damping or for the active control of the damping at least one electric machine is connected to the rotary damper. For example a permanently energized synchronous machine (PSM) can be used. However, other types of electric machines can also be used. To adjust the damping, the electric machine can advantageously be short-circuited by way of controllable resistances, or operated as a generator. It is also conceivable that the electric machine is driven by a motor in order to enable active regulation of the movement, for example, of the vehicle body or the vehicle wheels,

When the proposed rotary damper is combined with an electric machine, this has the advantage that a passive basic damping by means of the hydraulic pump integrated in the gear assembly can be combined with the passively or actively operated electric machine. This makes it possible to avoid overloads, loads due to misuse or the like, which with known active dampers cannot be kept under control, or only so with very considerable design effort and complexity.

As the gearing assembly, one or more of the gear systems mentioned below, for example a spur gear assembly, a planetary gear assembly, a cycloid gear assembly or suchlike, can be combined with one another. Preferably, as the hydraulic pump at least one gear pump, annular gear pump, sickle pump, gerotor pump or the like can be used. Alternatively, rotary piston pumps, reversing piston pumps, circular piston pumps, rotary vane pumps or suchlike assemblies can be used.

In a related embodiment of the invention it can be provided that, for example on the front-side housing of the gearing assembly, for example two electrodes electrically insulated from one another and of different polarity, or suchlike, can be provided. As the medium for the hydraulic pump integrated in the gearing assembly, for example an electro-rheological fluid (ERF or ERP) can be used, whose viscosity can be changed by the electric field between the electrodes provided in order to influence the damping additionally or alternatively to the valve or throttle.

As a preferred alternative a magneto-rheological fluid can also be used, whose viscosity in the line or in the pump space can be changed by a magnetic field. Advantageously, the viscosity is influenced directly in the hydraulic pump, in that for example the fluid in the pump spaces is polarized by a magnetic flux, for example in opposite directions. Advantageously, the pump spaces can be in magnetically functional connection with the pole-pieces of the electric machine in such manner that the coils in the electric machine produce the magnetic polarization of the pump spaces.

With the proposed rotary damper, in accordance with a related further development of the invention either one central, or several decentralized control units or suchlike can be used for control purposes, which for example are connected to the vehicle-internal data bus system or the like. For the signals available as standard in the vehicle, acceleration sensors on the wheel and on the vehicle body, or more generally on the masses to be damped, are provided. The sensors measure accelerations in the direction of the movements to be damped. On the vehicle body there are provided at least one and advantageously several sensors, in order to pick up all the modal degrees of freedom. Alternatively, at least one sensor can be arranged on the rotary damper, whereby additional cable connections can be saved. Furthermore a temperature sensor can be provided for each partially active rotary damper. By virtue of those sensors the electric machine can be monitored for safety and at the same time the temperature-dependence of the viscosity of the hydraulic medium in the hydraulic pump can be taken into account.

The rotary damper proposed can preferably be used for damping relative movements between vehicle wheels and the vehicle body. However, other possible uses are conceivable, for example in other machines, assemblies or the like.

### BRIEF DESCRIPTION OF THE DRAWINGS

Below, the present invention is explained in more detail with reference to the drawings, which show:

FIG. 1: A schematic view of a first embodiment variant of a rotary damper according to the invention with a gear pump integrated in a gear assembly;

FIG. 2: A schematic view of a further embodiment variant of the rotary damper, with two sickle pumps integrated in a gear assembly;

FIG. 3: A diagrammatic representation of the embodiment variant shown in FIG. 2;

FIG. 4: A schematic view of a related embodiment variant of the rotary damper, with several gear pumps integrated in a planetary gear assembly;

FIG. 5: A further schematic view of the embodiment variant according to FIG. 4; and

FIG. 6: Another embodiment variant of the rotary damper, with a gerotor pump integrated into a cycloid gear assembly.

### DETAILED DESCRIPTION OF THE PREFERRED EMBODIMENTS

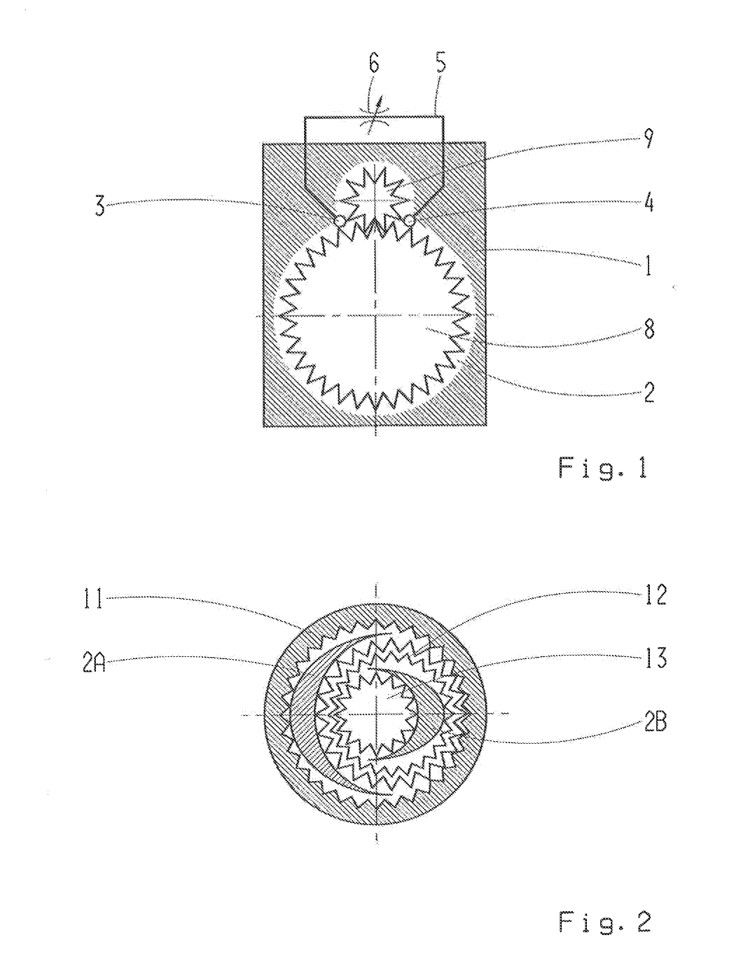

FIG. 1 shows a first embodiment variant of a rotary damper according to the invention, in which the gear assembly is in the form of a spur gear assembly and is enclosed by a housing 1 in such manner that at the same time a hydraulic pump in the form of a gear pump with a corresponding pump space 2 is provided, The gear pump has a suction side 3 and a pressure side 4. The suction side 3 and the pressure side 4 are short-circuited by a line 5 provided with an adjustable throttle 6 or valve in order to be able to adjust the hydraulic damping as desired.

The relative movement, for example between the vehicle wheels and the vehicle body, is converted by a lever 7 (not shown in more detail) into a rotary movement of a first spur gear 8 of the spur gear assembly. The first spur gear 8 engages with a smaller, second spur gear 9 so that the rotary movement of the first spur gear 8 is translated into a faster rotary movement of the second spur gear 9. On the shaft of the second spur gear 9 there is in addition an electric machine 10 (not shown in more detail), with which the hydraulic damping can be additionally actively controlled.

It is also possible for a multi-stage gear assembly to be used, which at the same time forms several hydraulic pumps. Preferably, the hydraulic pumps can be interconnected with one another in such manner that a hydraulic circuit with the same flow directions is produced, in that a control valve determines the degree of damping. It is also possible for the pressure sides of the pumps to be connected with one another in order to reinforce the short-circuit effect.

As an example, FIG. 2 shows a further embodiment variant of the rotary damper that has several gear assemblies. The gear assemblies form a number of sickle pumps nested in one another. To be specific, a two-stage gear system with two sickle pumps is provided. The relative movement to be damped is introduced as a rotary movement by way of a ring gear 11 which together with a toothed ring 12 form the first sickle pump or first gear pump, the toothed ring 12 being arranged eccentrically relative to the ring gear 11. The inner teeth of the ring gear 11 engage or are functionally connected with the outer teeth of the toothed ring 12 to form a first, sickle-shaped pump space 2A. In addition, a second sickle pump is formed between the toothed ring 12 and a spur gear 13 arranged concentrically with the ring gear 11, the inner teeth of the toothed ring 12 engaging or being functionally connected with the outer teeth of the spur gear 13 to form a second, sickle-shaped pump space 2B. The spur gear 13 drives the electric machine 10, to enable active control of the damping. This type of rotary damper has seals at the ends and/or flow channels, for example with adjustable cross-sections between the wheels and the housing.

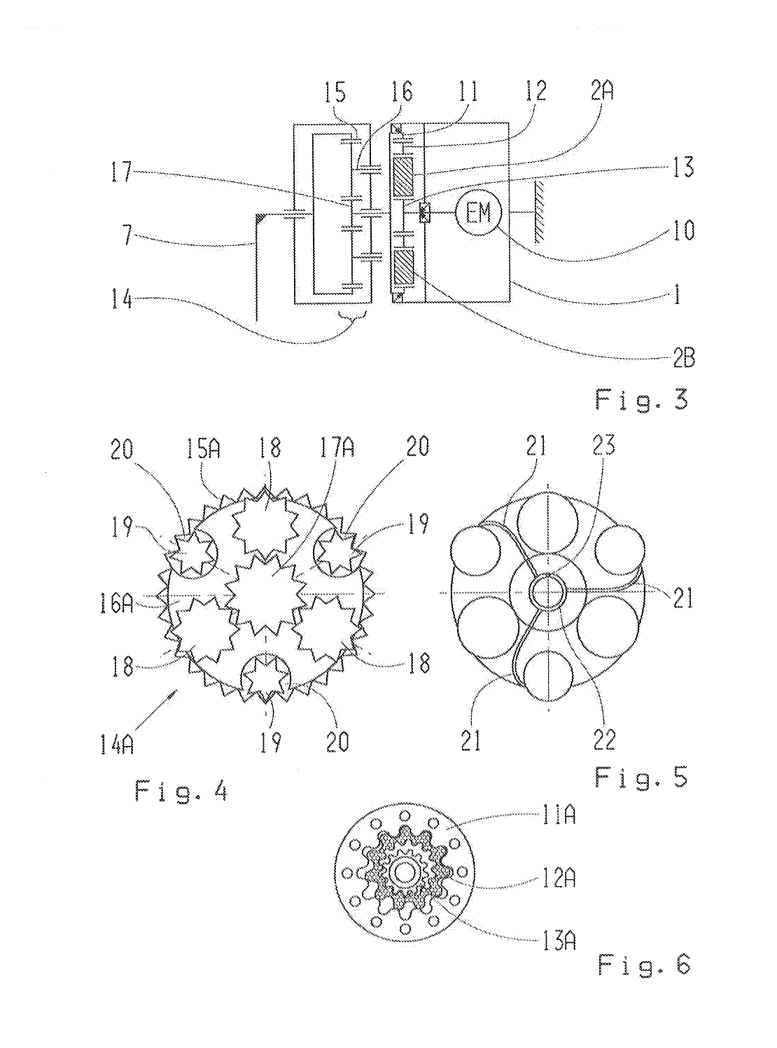

FIG. 3 shows a diagrammatic representation of the embodiment variant shown in FIG. 2, in which for example a planetary gear assembly 14 is connected upstream from the gear assembly that forms the sickle pumps. For example, the lever 7 is connected to a ring gear 15 of the planetary gear assembly 14, whereas the planetary gear carrier 16 is supported on the housing 1. The sun gear 17 is connected to the ring gear 11 of the first sickle pump. The spur gear 13 of the gearing assemblies that form the hydraulic pumps is connected to the electric machine 10. As hydraulic pumps, besides the sickle pumps gear pumps, annular gear pumps or the like can also be used.

An alternative embodiment variant of the rotary damper is shown in FIGS. 4 and 5. This variant is an integration of several gear pumps in a specially designed planetary gear assembly 14A, wherein additional or further planetary gearwheels 19 that act as gear pumps are arranged in the planetary gear assembly 14A. Besides the planetary gearwheels 18 that engage with the sun gear 17A, the further planetary gearwheels 19 are also mounted on the planetary carrier 16A and these also engage with the ring gear 15A of the planetary gear assembly. The planetary carrier 16A is designed in such manner that around the further planetary gearwheels 19 in each case a pump space 20 is formed, which in each case has a pressure side and a suction side.

On the axial sides of the planetary carrier 16A there are provided at the front and at the rear respective flow channels 21, which are indicated, for example on the suction side of the pump spaces 20, in FIG. 5. Corresponding channels for the pressure side are then either on the rear side or the front side of the planetary carrier 16A. The channels 21 open into an annular channel 22 which is connected by way of an axial duct 23 to the corresponding annular channel on the pressure side, In this way, in this embodiment variant as well, the pressure sides and the suction sides are short-circuited with one another. Here too, a controllable valve or a throttle can be provided.

In particular, the diameter of the annular channel 22 is larger than that of the shaft for the gearwheel 17A, which leads through the planetary carrier 16A.

A further alternative embodiment variant of the proposed rotary damper is illustrated in FIG. 6. In this case the gear assembly is in the form of a cycloid gear assembly, in which a gerotor pump is integrated. Alternatively, rotary piston pumps, reversing piston pumps, circular piston pumps, rotary vane pumps or the like can be used.

With the gerotor pump, in a manner similar to the embodiment variant according to FIG. 2 a ring gear 11A is provided with inner teeth, which engage with a toothed ring 12A. In turn, the inner teeth of the toothed ring 12A engage with a spur gear 13A designed in effect as a sun gear, for example in order to drive the electric machine 10. The ring gear 11A is made to rotate by the relative movement, by way of the lever 7.

Regardless of the embodiment variant concerned, a further gear assembly without any hydraulic pump function can optionally be arranged before, after or between the at least one hydraulic pump. For protection against overload, the electric machine 10 can for example be connected to the last gear assembly by way of a slipping clutch or suchlike. After the rotor of the electric machine 10 further transmission stages or hydraulic pumps can follow.

### INDEXES

1 Housing
2, 2A, 23 Pump space
3 Suction side
4 Pressure side
5 Line
6 Throttle
7 Lever
8 First spur gear
9 Second spur gear
10 Electric machine
11, 11A Ring gear
12, 12A Toothed ring
13, 13A Spur gear
14, 14A Planetary gear assembly
15, 15A Ring gear
16, 16A Planetary carrier
17, 17A Sun gear
18 Planetary gearwheels
19 Additional further planetary gearwheels
20 Pump spaces
21 Flow channels
22 Annular channel
23 Axial duct

1-21. (canceled)

22. A rotary damper for a vehicle for damping relative movements between vehicle wheels and a body of the vehicle, the rotary damper comprising:
at least one gear assembly with several gearwheels in functional connection, and
by virtue of rotational movement of the several gearwheels, hydraulic medium is displaced for hydraulic damping of the vehicle.

23. The rotary damper according to claim 22, wherein at least one hydraulic pump integrated in the gear assembly.

24. The rotary damper according to claim 22, wherein the gear assembly is at least one of:
at least one spur gear assembly,
at least one planetary gear assembly, and
at least one cycloid gear assembly.

25. The rotary damper according to claim 22, wherein the hydraulic pump is at least one of:
at least one gear pump,
at least one annular gear pump,
at least one sickle pump, and
at least one gerotor pump.

26. The rotary damper according to claim 23, wherein the gear assembly is in a form of a spur gear assembly, which is arranged in a housing (1) so that a gear pump with a pump space (2), having a suction side (3) and a pressure side (4), is provided as the hydraulic pump, and the suction side (3) and the pressure side (4) of the pump space are connected to one another for the hydraulic damping.

27. The rotary damper according to claim 26, wherein the relative movement is transmitted, by way of a lever (7), as rotational movement to a first spur gear (8) of the spur gear assembly, and a second spur gear (9) engaged with the first spur gear (8) is connected to an electric machine (10) for either actively varying the damping or recuperation of energy.

28. The rotary damper according to claim 22, wherein several gear assemblies are provided which form several hydraulic pumps nested with one another.

29. The rotary damper according to claim 28, wherein a first sickle pump comprises a ring gear (11) and a toothed ring (12) arranged eccentrically relative thereto such that inner teeth of the ring gear (11) and outer teeth of the toothed ring (12) engaged and form a first sickle-shaped pump space (2A).

30. The rotary damper according to claim 29, wherein a second sickle pump, arranged concentrically with the ring gear (11), is provided between the toothed ring (12) and a spur gear (13) so that inner teeth of the toothed ring (12) engage with outer teeth of the spur gear (13) to form a second sickle-shaped pump space (2B).

31. The rotary damper according to claim 29, wherein the ring gear (11) is either directly or indirectly connected, via a sun gear (17) of an upstream planetary gear assembly (14), to the lever (7) for transmitting the relative movement.

32. The rotary damper according to claim 30, wherein the spur gear (13), that is arranged concentrically with the ring gear (11), is connected to an electric machine (10).

33. The rotary damper according to claim 22, wherein several hydraulic pumps are integrated in one planetary gear assembly (14A).

34. The rotary damper according to claim 33, wherein beside planetary gearwheels (18) engaged with a sun gear (17A), further planetary gearwheels (19) are mounted on a planetary carrier (16A) which engage with a ring gear (11A), and the planetary carrier (16A) is designed so that a pump space (20) with a pressure side and a suction side is provided around the further planetary gearwheels (19).

35. The rotary damper according to claim 34, wherein flow channels (21) are provided on axial sides, at a front and at rear of the planetary carrier (16A), which connect the pressure sides and the suction sides of the pump spaces (20) associated with the further planetary gearwheels (19).

36. The rotary damper according to claim 35, wherein the flow channels (21) open into an associated annular channel (22) so that the annular channels (22) of the suction sides and the pressure sides are connected by way of an axial duct (23).

37. The rotary damper according to claim 22, wherein a cycloid gear assembly is provided in which a gerotor pump is integrated.

38. The rotary damper according to claim 22, wherein an electric machine (10) is connected, via a supping clutch, to the gear assembly containing the at least one hydraulic pump.

39. The rotary damper according to claim 22, wherein a housing (1) of the gear assembly comprises two electrodes that are insulated relative to one another, and the hydraulic medium is either an electro-rheological fluid or an electro-rheological paste which has a viscosity that is adjustable by an electric field produced by the two electrodes.

40. The rotary damper according to claim 22, wherein the hydraulic medium is a magneto-rheological fluid which has a viscosity that is adjustable by a magnetic field produced by an electric machine (10).

41. The rotary damper according to claim 22, wherein either at least one central control unit or several decentralized control units control the hydraulic damping and are connected to a data bus system on-board the vehicle.

42. The rotary damper according to claim 41, wherein the at least one central control unit or the several decentralized control units are connected to at least one sensor for communication of signals.
